(19) United States
(12) Patent Application Publication
(10) Pub. No.: US 2021/0150053 A1
(43) Pub. Date: May 20, 2021

(54) METHOD, DEVICE, AND STORAGE MEDIUM FOR IMAGE DESENSITIZATION

(71) Applicant: Alibaba Group Holding Limited, Grand Cayman (KY)

(72) Inventors: Ke CAO, Hangzhou (CN); Jun QIU, Hangzhou (CN); Wei LI, Hangzhou (CN)

(21) Appl. No.: 17/047,519

(22) PCT Filed: Apr. 15, 2019
(86) PCT No.: PCT/CN2019/082647

§ 371 Date: Oct. 14, 2020

(30) Foreign Application Priority Data
Apr. 16, 2018 (CN) 201810339029.0

(51) Int. Cl. G06F 21/62; G06F 3/0484; G06K 9/20; G06K 9/46

(52) U.S. Cl. CPC G06F 21/6245; G06F 3/04842; G06K 2209/01; G06K 9/4652; G06K 9/2081

(57) ABSTRACT

Embodiments of the disclosure provide methods, electronic devices, and computer-readable storage media for image desensitization. In the embodiments of the disclosure, for an image to be desensitized, mage areas having content related to the content of a partial image area that needs to be desensitized are automatically recognized based on the partial image area. Alternatively, an image area to be desensitized is automatically recognized based on a desensitization rule corresponding to a service scenario with which the image to be desensitized is associated. Alternatively, a complete set of image areas to be desensitized is acquired by automatic extension based on a selected partial image area.

### CROSS-REFERENCE TO RELATED APPLICATIONS

The present application is a national stage entry of Int'l Appl. No. PCT/CN2019/082647, filed on Apr. 15, 2019, which claims priority to Chinese Patent Application No. 201810339029.0, filed on Apr. 16, 2018, both of which are incorporated by reference herein in their entirety.

### BACKGROUND

### Technical Field

The disclosure relates to the technical field of image processing, and in particular, to methods, electronic devices, and storage media for image desensitization.

### Description of the Related Art

With the development of communication technologies and smart devices, a user uses a smart device to send and receive various messages, such as short messages, multimedia messages, in-application messages, instant messaging messages, etc. The content of these messages includes, for example, text, images, audio, videos, and the like.

Containing a greater amount of information and more intuitive in terms of expressing emotions and describing things, images have gradually become a common information medium for interactions between users. However, an image may include sensitive business information or private personal information. To prevent unnecessary losses caused by the leakage of such information, a user needs to desensitize such information in an image before sending.

Presently, with image-related applications providing image editing functions (e.g., cropping, marking, and so on), a user can select tools (e.g., a painting brush) corresponding to these editing functions to modify an image area that needs to be desensitized to erase or obfuscate the information that needs to be desensitized. However, such a desensitization method is cumbersome in operation and inefficient.

### SUMMARY

Embodiments of the disclosure provide methods, electronic devices, and computer-readable storage media for image desensitization of simplified operations and improved efficiency.

In one embodiment, the disclosure provides a method for image desensitization, the method comprising: determining, in an image for desensitization, a first image area that needs to be desensitized; recognizing, in the image for desensitization, a second image area having content related to the content of the first image area; and desensitizing the first image area and the second image area.

In one embodiment, the disclosure provides an electronic device, the electronic device comprising a memory, and a processor coupled to the memory, wherein the memory is used to store a computer program that, when executed by the processor, instructs the electronic device to determine, in an image for desensitization, a first image area that needs to be desensitized; recognize, in the image for desensitization, a second image area having content related to the content of the first image area; and desensitize the first image area and the second image area.

In one embodiment, the disclosure provides a computer-readable storage medium having a computer program stored thereon that, when executed by a processor, causes the processor to perform the methods for image desensitization of the disclosure.

In one embodiment, the disclosure provides a method for image desensitization, the method comprising: acquiring an image for desensitization; determining a service scenario with which the image for desensitization is associated; recognizing in the image for desensitization, an image area to be desensitized based on a desensitization rule corresponding to the service scenario; and desensitizing the image area to be desensitized.

In one embodiment, the disclosure provides an electronic device, the electronic device comprising a memory, and a processor coupled to the memory, wherein the memory is used to store a computer program that, when executed by the processor, instructs the electronic device to acquire an image for desensitization; determine a service scenario with which the image is associated; recognize in the image for desensitization, an image area to be desensitized based on a desensitization rule corresponding to the service scenario; and desensitize the image area.

In one embodiment, the disclosure provides a computer-readable storage medium having a computer program stored thereon that, when executed by a processor, causes the processor to perform the methods for image desensitization of the disclosure.

In one embodiment, the disclosure provides a method for image desensitization, the method comprising: determining, in response to an area selection operation, a partial image area in an image for desensitization; performing a content integrity extension on the partial image area to acquire an image area to be desensitized; and desensitizing the image area to be desensitized.

In one embodiment, the disclosure provides an electronic device, the electronic device comprising a memory, and a processor coupled to the memory, wherein the memory is used to store a computer program that, when executed by the processor, instructs the electronic device to: determine in response to an area selection operation, a selected partial image area in an image for desensitization; perform a content integrity extension on the partial image area to acquire an image area to be desensitized; and desensitize the image area to be desensitized.

In one embodiment, the disclosure provides a computer-readable storage medium having a computer program stored thereon that, when executed by a processor, causes the processor to perform the methods for image desensitization of the disclosure.

According to various embodiments of the disclosure, for an image for desensitization, image areas having content related to the content of an image area that needs to be desensitized are automatically recognized, based on the image area. These image areas are desensitized together. Additionally or alternatively, an image area to be desensitized is automatically recognized, based on a desensitization rule corresponding to a service scenario with which the image for desensitization is associated, for desensitization. Further, additionally or alternatively, a complete set of image areas to be desensitized is acquired by automatic extension based on a selected partial image area, for desensitization. These desensitization methods simplify desensitizing operations at different aspects, thereby improving the efficiency of desensitization.

### BRIEF DESCRIPTION OF THE DRAWINGS

The accompanying drawings described herein are used to provide a further understanding of the disclosure and constitute a part of the disclosure. Embodiments of the disclosure and the description thereof are used to explain the disclosure instead of constituting improper limitations to the disclosure.

FIG. 1A is a flow diagram illustrating a method for image desensitization according to some embodiments of the disclosure.

FIG. 1B is a schematic diagram illustrating an application scenario requiring image desensitization according to some embodiments of the disclosure.

FIG. 1C is a schematic diagram illustrating an application scenario requiring image desensitization according to some embodiments of the disclosure.

FIG. 1D is a schematic diagram illustrating a relationship between a first image area and a second image area in an image for desensitization according to some embodiments of the disclosure.

FIG. 1E is a schematic diagram illustrating a relationship between a first image area and a second image area in an image for desensitization according to some embodiments of the disclosure.

FIG. 1F is a schematic diagram illustrating a desensitization effect on an image for desensitization according to some embodiments of the disclosure.

FIG. 2A is a flow diagram illustrating a method for image desensitization according to some embodiments of the disclosure.

FIG. 2B is a flow diagram illustrating a method for image desensitization according to some embodiments of the disclosure.

FIG. 2C is a schematic diagram illustrating a relationship between an image area selected by a second operation and a first image area in an image for desensitization according to some embodiments of the disclosure.

FIG. 2D is a flow diagram illustrating a method for image desensitization according to some embodiments of the disclosure.

FIG. 3 is a flow diagram illustrating a method for image desensitization according to some embodiments of the disclosure.

FIG. 4A is a flow diagram illustrating a method for image desensitization according to some embodiments of the disclosure.

FIG. 4B is a flow diagram illustrating a method for image desensitization according to some embodiments of the disclosure.

FIG. 5A is a block diagram illustrating an apparatus for image desensitization according to some embodiments of the disclosure.

FIG. 5B is a block diagram illustrating an electronic device according to some embodiments of the disclosure.

FIG. 6A is a block diagram illustrating an apparatus for image desensitization according to some embodiments of the disclosure.

FIG. 6B is a block diagram illustrating an electronic device according to some embodiments of the disclosure.

FIG. 7A is a block diagram illustrating an apparatus for image desensitization according to some embodiments of the disclosure.

FIG. 7B is a block diagram illustrating an electronic device according to some embodiments of the disclosure.

### DETAILED DESCRIPTION

To make the objectives, technical solutions, and advantages of the disclosure clearer, the technical solutions in the disclosure will be clearly and completely described below with reference to the embodiments and the corresponding accompanying drawings of the disclosure. The embodiments described herein are merely some rather than all of the embodiments of the disclosure. Based on the embodiments of the disclosure, all other embodiments obtained by those skilled in the art without making significant efforts shall fall within the scope of the disclosure.

Addressing the technical problems that present image desensitization techniques are cumbersome in operation and inefficient, embodiments of the disclosure provide improved solutions for image desensitization. According to various embodiments, methods for image desensitization simplify desensitizing operations at various aspects, thereby improving the efficiency of desensitization. Embodiments of image desensitization solutions are described below.

In some embodiments, based on a first image area (in an image) that needs to be desensitized, other second image areas, which have content related to the content of the first image area and need to be desensitized, are automatically recognized for desensitization. In one embodiment, the first and second image areas are desensitized together. As the second image area that needs to be desensitized does not need to be manually selected by a user, the number of manual operations to select image areas by the user for desensitization is reduced, thereby simplifying desensitization operations, and improving the efficiency of desensitization.

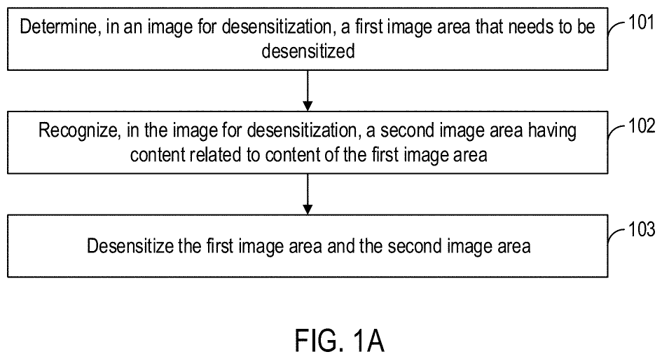

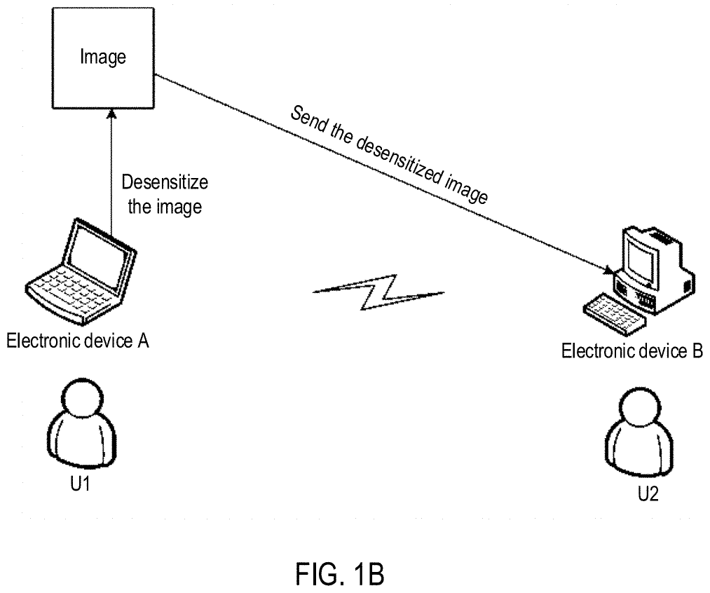

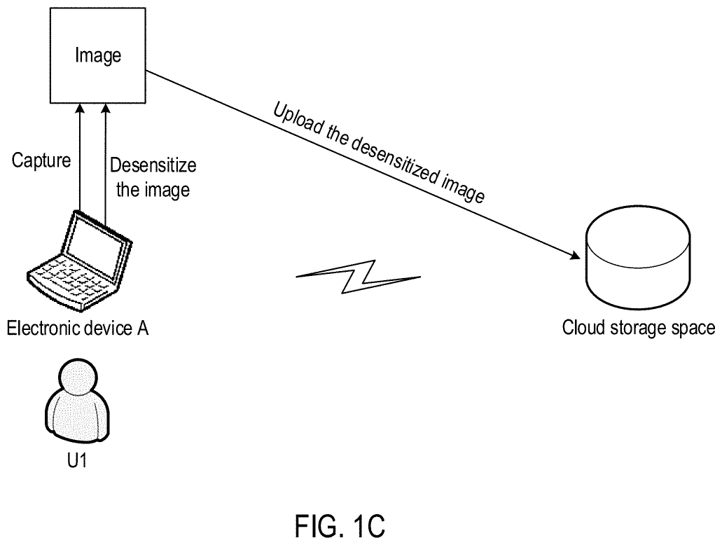

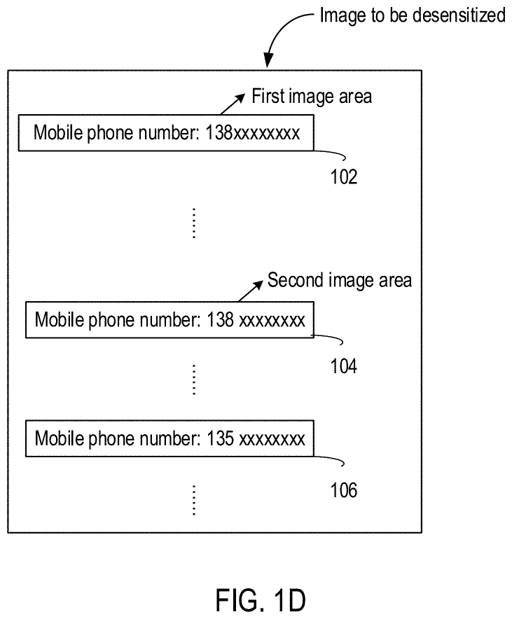

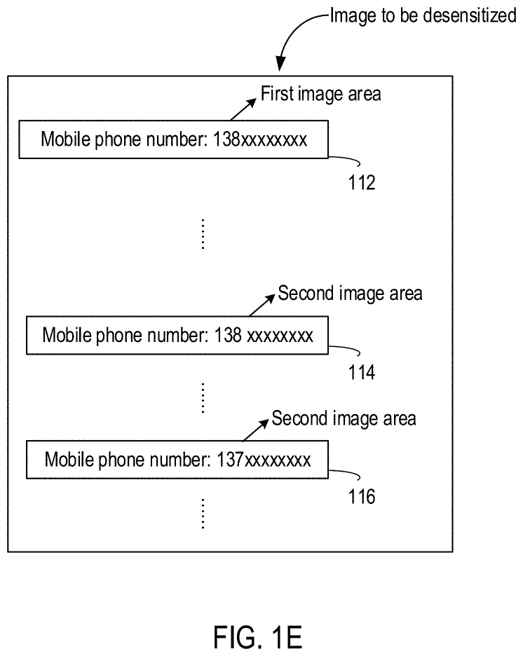

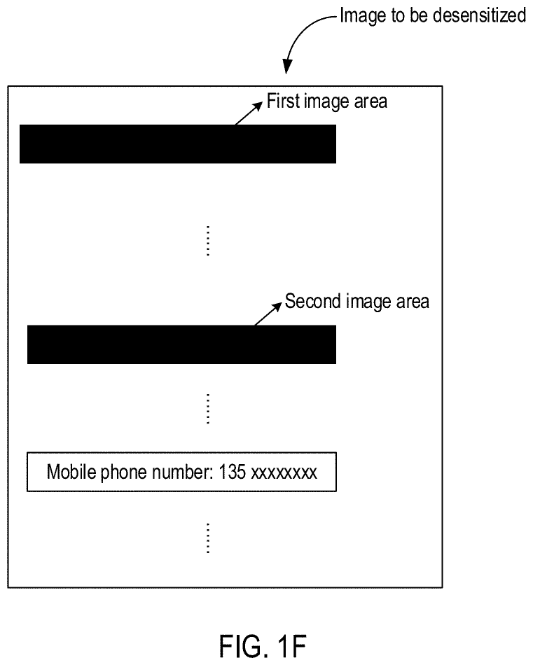

FIG. 1A is a flow diagram illustrating a method for image desensitization according to some embodiments of the disclosure. In some embodiments, and as shown in FIG. 1A, the method includes the following steps.

Step 101: determine, in an image for desensitization, a first image area that needs to be desensitized.

Step 102: recognize in the image for desensitization, a second image area having content related to the content of the first image area.

Step 103: desensitize the first image area and the second image area.

According to various embodiments, the method for image desensitization is applicable to any electronic device that needs to perform image desensitization. Such electronic devices include any device having computing and processing capabilities. For example, an electronic device is a client device (e.g., a desktop computer, a personal computer, a tablet computer, a smartphone, etc.). In another example, an electronic device is a server device (e.g., a conventional server, a cloud server, a cloud host, a virtual center, etc.). In one example, a server device includes a processor, a hard disk, a memory, a system bus, etc., similar to the architecture of a general-purpose computer.

In application scenarios of an electronic device, images may need to be desensitized. In one example, and as shown in the scenario of FIG. 1B, a user U1 uses his/her electronic device A to send an image to an electronic device B of a user U2. To avoid the leakage of sensitive business information or private personal information, the image is desensitized before it is sent. In another example, and as shown in a scenario in FIG. 1C, user U1 uses his/her electronic device A to capture an image and uploads the captured image to a cloud storage space. To avoid the leakage of facial information and/or background information in the image, the image is desensitized before it is uploaded. In another example, the user regularly or irregularly checks in a local image gallery of his/her electronic device to determine whether there is an image that needs to be desensitized, and in turn, desensitizes such an image identified.

In some embodiments, an image that needs to be desensitized is referred to as an image for desensitization. Depending on different application scenarios, methods for identifying an image for desensitization are different. For example, in some scenarios, a user selects an image for desensitization from a local image gallery on an electronic device. The electronic device is configured to acquire, in response to an operation performed by the user to select the image from the local image gallery, an image selected by the user as the image for desensitization. In other application scenarios, the user performs a screenshotting operation on a screen of the electronic device. The electronic device is configured to acquire a screenshot image of the current screen, in response to the screenshotting operation performed by the user, as the image for desensitization. In other scenarios, the electronic device is configured to identify an image generated and/or received by applications installed thereon as the image for desensitization. Such applications include, for example, instant messaging applications involving private information of an individual or proprietary information of an enterprise, enterprise applications involving proprietary information of an enterprise, e-commerce applications involving personal information, health management applications involving private personal information, and the like.

After the image for desensitization is identified, a first image area that needs to be desensitized in the image is determined. The first image area is a partial image area in the image for desensitization. The partial image area includes sensitive information and therefore needs to be desensitized. In some embodiments, the first image area is an image area, including sensitive information that is relatively complete in meaning. In one example, and as shown in FIGS. 1D-E, the first image area is an area including a complete phone number. Any suitable techniques can be applied to determine a first image area. For instance, the first image area is manually determined by the user; or automatically determined based on a desensitization rule.

In some scenarios, the image for desensitization includes correlating content. To further reduce the risk of information leakage, it is necessary to desensitize all of the related content. As such, after the first image area is determined, other image areas related to the content of the first image area (e.g., other image areas having content related to the content of the first image area), are recognized in the image by techniques of image recognition. This way, based on content relevance, other image areas are determined as second image areas. A second image area is another image area to be desensitized in the image for desensitization. In various embodiments, the second image areas can include one or multiple second image areas.

After the first image area is determined, and the second image areas having content related to the content of the first image area are recognized, the first image area and the second image areas are desensitized.

Presently, a user manually determines an image area for desensitization. For example, the user modifies (e.g., smears or blurs) the image for desensitization, the modified area being determined as the image area that needs to be desensitized. As the image area is manually determined by the user, area boundaries are difficult to delineate. In some cases, the user needs to perform the operations multiple times before the image area for desensitization can be accurately determined. As such, the complexity of image desensitization operations is increased; and the efficiency of image desensitization is decreased. In contrast, according to embodiments of the disclosure, after a first image area that needs to be desensitized in the image for desensitization is determined, a second image area, having content related to the content of the first image area, is automatically recognized in the image. As a result, the user does not need to manually determine the second image area. Therefore, the number of operations to manually determine an image area by the user is reduced, thereby simplifying image desensitization operations, and improving the efficiency of image desensitization.

As used herein, the term “having related content” is not defined with any limitation and can be adaptively defined depending on different application scenarios. The following embodiments illustrate exemplary definitions of “having related content,” without imposing any limitations.

Example 1: “having related content” is defined as having the same content. Based on this definition, when the second image area having content related to the content of the first image area is recognized in the image for desensitization, an image area including the same content of the first image area is acquired from the image for desensitization, the image area being identified as the second image area.

As shown in FIG. 1D, two image areas 102 and 104 in the image for desensitization include the same content of a mobile phone number “138xxxxxxxx,” and another image area 106 includes the content of another mobile phone number “135xxxxxxxx.” After the first image area including the content of the mobile phone number “138xxxxxxxx” is determined (as the image area 102), other image areas (e.g., image area 104) including the content of the same mobile phone number “138xxxxxxxx” in the image is automatically recognized, and identified as the second image areas.

Example 2: “having related content” is defined as having content that belongs to the same category. Based on this, when the second image area having content related to the content of the first image area is recognized in the image, an image area including content belonging to the same category as that of the content included in the first image area is acquired from the image, and identified as the second image area.

In the example shown in FIG. 1E, two image areas 112 and 114 in the image for desensitization include information of two mobile phone numbers “138xxxxxxxx,” while another image area 116 includes information of another mobile phone number “137xxxxxxxx.” After the image area 112 including the mobile phone number “138xxxxxxxx” is determined as the first image area, other image areas including a mobile phone number are automatically recognized. Here, the image area 116 including the mobile phone number “137xxxxxxxx” and the image area 114 including the mobile phone number “138xxxxxxxx” in FIG. 1E are automatically recognized as the second image areas.

In the above-described Example 1 and Example 2, a “mobile phone number” is used as exemplary content included in the first image area to illustrate embodiments of “the same content” and “content belonging to the same category.” In various embodiments, besides a mobile phone number, the content included in the first image area comprises content of any form, such as a name, an avatar, a nickname, an account name, a home address, an identification card number, a company name, a product name, a product price, a quote, decision-making information, time information, and the like.

In some embodiments, after the first image area is determined, and the second image area related to the content of the first image area is recognized, the first image area and the second image area are desensitized. An exemplary desensitization effect on the image for desensitization is shown in FIG. 1F.

In some embodiments, a desensitization method is selected or determined, based on which the first image area and the second image area are desensitized. In one embodiment, before the first image area and the second image area are determined, a corresponding desensitization method is pre-selected or pre-determined. In another embodiment, after the first image area and the second image area are determined, and during the process of desensitizing the first image area and the second image area, a corresponding desensitization method is selected or determined for the first image area and the second image area.

In some embodiments, a default desensitization method is preset. For example, mosaicing, smearing, blurring, and/or text substitution may be set as the default desensitization method. As such, after the first image area is determined, and the second image area related to the content of the first image area is recognized, the default desensitization method is performed to desensitize the first image area and the second image area. This way, the default desensitization method is directly performed to desensitize the first image area and the second image area, thereby further improving the efficiency of desensitization.

In some embodiments, a plurality of desensitization methods such as mosaicing, smearing, blurring, text substitution, and the like are provided to the user for selection. This way, the desensitization requirements of the user are better satisfied. As such, after the first image area is determined, and the second image area related to the content of the first image area is recognized, the user performs an operation to select a desensitization method. Subsequently, the desensitization method selected by the user is determined in response to the user's selection of the desensitization method, which is, in turn, used to desensitize the first image area and the second image area.

In some embodiments, an interface for desensitization method selection is displayed to the user. The interface is configured to include the respective titles and/or icons corresponding to a plurality of desensitization methods for selection by the user. The user selects a desensitization method via the operable options provided at the interface. For example, the user selects a desensitization method from the plurality of desensitization methods by ticking, clicking, touching, hovering, etc., at the interface.

In some embodiments, when the above-described default desensitization method or the desensitization method selected by the user is to construct mosaics (e.g., mosaicing), the first image area and the second image area are mosaiced to achieve desensitization. In one embodiment, the process of mosaicing is dynamically displayed.

In some embodiments, when the above-described default desensitization method or the desensitization method selected by the user is to perform smearing, a smearing layer is added to the first image area and the second image area to achieve desensitization. In one embodiment, the process of adding the smearing layer is dynamically displayed.

In some embodiments, when the above-described default desensitization method or the desensitization method selected by the user is to perform text substitution, the information in the first image area and the second image area is substituted with other information to achieve desensitization. In one embodiment, the process of text substitution is dynamically displayed.

In some embodiments, during the process of desensitizing the first image area and the second image area, an electronic device is configured to display a desensitization confirmation interface to the user. This way, the user confirms whether to desensitize the first image area and the second image area. In some embodiments, the user confirms whether to desensitize the first image area and the second image area via the desensitization confirmation interface. When confirming that the first image area and the second image area need to be desensitized, the user performs a confirmation operation at the desensitization confirmation interface. For example, the user clicks or ticks a “Confirm” or “Yes” button on the desensitization confirmation interface. The electronic device is, in turn, configured to desensitize the first image area and the second image area in response to the confirmation operation of the user. In one embodiment, before the first image area and the second image area are desensitized, the user confirms whether to continue to perform desensitization such that the user can discover and correct, in a timely manner, an image area that does not need to be desensitized, thereby reducing the probability of false desensitization.

In some embodiments, during the process of desensitizing the first image area and the second image area, the electronic device is configured to display an area selection interface to the user. This way, the user selects, from the first image area and the second image area, a finalized image area that needs to be desensitized. In some embodiments, the user selects, via the area selection interface, the finalized image area that needs to be desensitized. For example, the user selects only the first image area for desensitization, or only the second image area for desensitization, or both the first image area and the second image area for desensitization. The electronic device is configured to desensitize, in response to the user's selection of the finalized desensitization area, the image area selected by the user. The image area selected by the user includes the first image area and/or the second image area. In some embodiments, the area selection interface includes information (e.g., serial numbers, titles, and the like) that corresponds to the first image area and the second image area to make it convenient for the user to select the finalized image area that needs to be desensitized. This way, before the first image area and the second image area are desensitized, the user selects the finalized image area that needs to be desensitized to achieve a combination of automatic selection and manual confirmation, thereby meeting desensitization requirements of the user, and enhancing user experience.

In some embodiments, the process of selecting the first image area and the second image area are repeated multiple times. For example, an image area having the content of a mobile phone number (e.g., a first image area) is first selected; and other image areas having the content of mobile phone numbers (e.g., second image areas) are automatically identified as the second image areas (e.g., extending the designation of image areas for desensitization to include the other image areas). Next, an image area having the content of a monetary amount (e.g., another first image area) is further selected; and other image areas having the content of monetary amounts (e.g., other second image areas) are automatically identified as the second image areas (e.g., extending the designation of image areas for desensitization to include the other image areas). Further, when the user is required to confirm whether to perform desensitization on the identified image areas, the user performs a confirmation operation once to confirm the desensitization on all of the selected image areas that need to be desensitized. Alternatively, the user performs confirmation operations on respective image areas of different types to desensitize the selected image areas that need to be desensitized.

In some embodiments, after the second image area is automatically recognized, manual selection of image areas for desensitization is further used in combination to acquire more methods for image desensitization. For example, image areas including the content of a phone number are automatically selected, and then other image areas missed by the automatic selection (e.g., image areas including the content of phone numbers but not accurately recognized by the automatic selection, image areas having the content of monetary amounts) are manually selected. For another example, image areas including the content of a phone number are automatically selected, and then some of the selected areas (e.g., image areas mistakenly recognized as the image areas including the content of phone number, or image areas that do not need to be desensitized) are manually deselected.

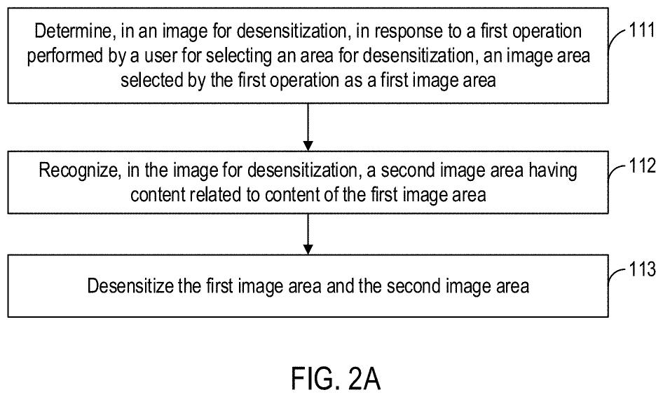

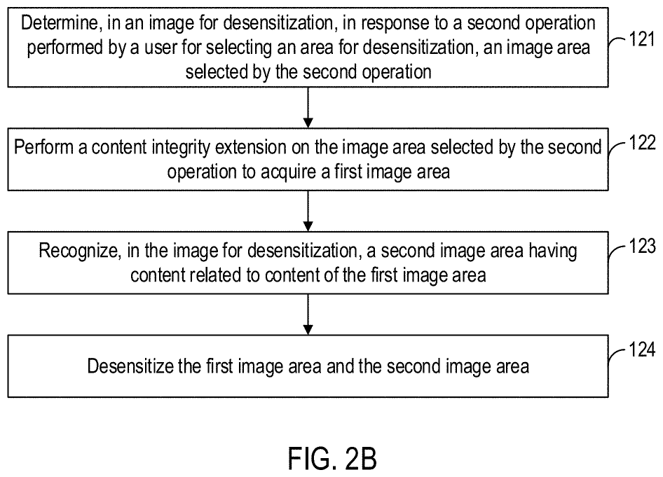

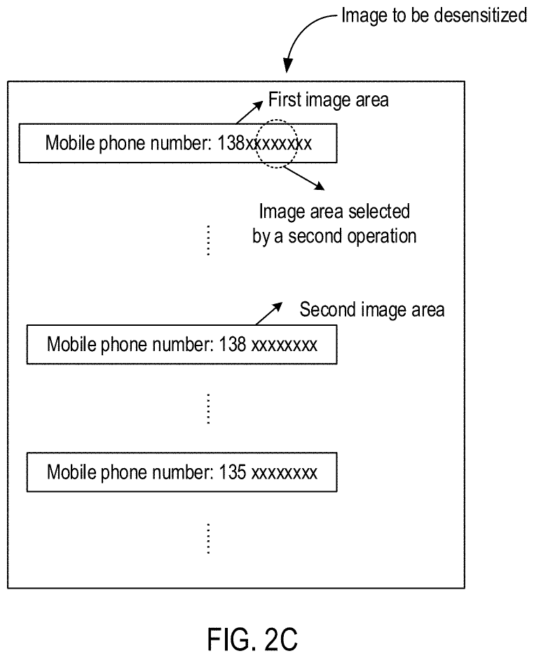

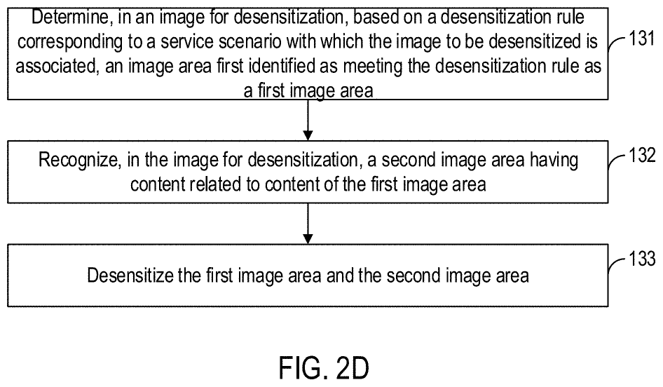

FIG. 2A is a flow diagram illustrating a method for image desensitization according to some embodiments of the disclosure. In some embodiments, and as shown in FIG. 2A, the method includes the following steps.

Step 111: determine, in an image for desensitization, in response to a first operation performed by a user for selecting an area for desensitization, an image area selected by the first operation as a first image area.

Step 112: recognize, in the image for desensitization, a second image area having content related to the content of the first image area.

Step 113: desensitize the first image area and the second image area.

In some embodiments, after an image for desensitization is determined, the user performs a selection operation on the image to manually select a first image area. In some embodiments, the image area selected by such operation is determined as the first image area. For the purpose of clarity in illustration, the operation performed by the user for selecting an area for desensitization is referred to herein as a first operation. In some embodiments, the first operation includes user operations that completely designate the first image area. In implementations, the first image area is an image area including sensitive information that is relatively complete in meaning. For example, the first image area is an image area including the information of a complete phone number, as shown in FIGS. 1D-E.

According to various embodiments, any techniques can be applied to performing the first operation, without limitation. The following illustrates examples of the first operations.

Example A1: the first operation is a sliding operation performed by the user on the image for desensitization. As such, in step 111, in response to the sliding operation performed by the user on the image for desensitization, an image area that has been slid across by the sliding operation is determined as the first image area.

Example A2: the first operation is a clicking operation performed by the user on the image for desensitization. As such, in step 111, in response to the clicking operation performed by the user on the image for desensitization, an image area that has been clicked by the clicking operation is determined as the first image area.

Example A3: the first operation is a boxing operation performed by the user on the image for desensitization. As such in step 111, in response to the boxing operation performed by the user on the image for desensitization, an image area that has been boxed by the boxing operation is determined as the first image area.

In some embodiments, the first image area is manually selected by the user, which is different from the embodiments shown in FIG. 1A. Other steps are substantially similar to those described in connection to FIG. 1A, and therefore for the purpose of simplicity in illustration, the details of which are not repeated.

According to various embodiments, a user needs only to manually determine, in an image for desensitization, a first image area that needs to be desensitized; and a second image area having content related to the content of the first image area is automatically recognized in the image. As such, the user does not need to manually determine the second image area. Therefore, operations to manually determine image areas by the user are reduced, thereby simplifying image desensitization operations, and improving the efficiency of image desensitization.

FIG. 2B is a flow diagram illustrating a method for image desensitization according to some embodiments of the disclosure. In some embodiments, and as shown in FIG. 2B, the method includes the following steps.

Step 121: determine, in an image for desensitization, in response to a second operation performed by a user for selecting an area for desensitization, an image area selected by the second operation.

Step 122: perform a content integrity extension on the image area selected by the second operation to acquire a first image area.

Step 123: recognize, in the image for desensitization, a second image area having content related to the content of the first image area.

Step 124: desensitize the first image area and the second image area.

In some embodiments, after an image for desensitization is determined, the user performs a selection operation on the image for desensitization to manually select a partial image area for the first image area. Next, a content integrity extension on the partial image area selected is performed to acquire the first image area. For the purpose of clarity in illustration, the operation performed by the user for selecting an area for desensitization is referred herein to as a second operation. In some embodiments, the second operation includes a user operation by which at least a partial image area in the first image area is selected.

In some embodiments, the second operation includes a user operation by which a partial image area in the first image area is selected. As shown in FIG. 2C, an image area, in which a complete phone number is located, is the first image area; and the second operation selects a partial image area in the first image area. For example, an area enclosed by a dotted circle is the partial image area selected by the second operation.

According to various embodiments, any techniques can be applied to performing the second operation. The following illustrates examples of the second operations.

Example B1: the second operation is a sliding operation performed by the user on the image for desensitization. As such, in step 121, in response to the sliding operation performed by the user on the image for desensitization, an image area that has been slid across by the sliding operation is determined.

Example B2: the second operation is a clicking operation performed by the user on the image for desensitization. As such, in step 121, in response to the clicking operation performed by the user on the image for desensitization, an image area that has been clicked by the clicking operation is determined.

Example B3: the second operation is a boxing operation performed by the user on the image for desensitization. As such, in step 121, in response to the boxing operation performed by the user on the image for desensitization, an image area that has been boxed by the boxing operation is determined.

In some embodiments, after the image area selected by the second operation is determined, a content integrity extension is performed on the image area selected by the second operation based on attributes of the image area selected by the second operation. For example, a content block generally has the same color in an image. Therefore, the image area selected by the second operation is extended, based on the color of the image area selected by the second operation, to the boundary of a content block to which the image area belongs, to acquire the first image area. For another example, the text content of a content block is continuous in an image. Therefore, the image area selected by the second operation is extended, based on the text content of the image area selected by the second operation, to the boundary of a content block to which the image area belongs, to acquire the first image area.

In some embodiments, the user manually selects a partial image area, by an automatic extension on which the first image area is obtained. This aspect is different from the embodiments of FIG. 1A and FIG. 2A. Other steps are substantially similar to those in the embodiments described in connection with FIG. 1A and FIG. 2A, and therefore, for the purpose of simplicity, the details of which are not repeated.

In various embodiments, a user needs only to manually determine a partial image area for the first image area that needs to be desensitized. Subsequently, the first image area is acquired by an automatic extension on the partial image area; and the second image area having content related to the content of the first image area in the image for desensitization is automatically recognized. In the whole process, the user does not need to manually determine the boundary of any image area, thereby solving the problem that a boundary is difficult to delineate during manual designation of an image area that needs to be desensitized. Furthermore, the user does not need to manually determine the second image area. As such, operations to manually determine an image area by the user are reduced, thereby simplifying image desensitization operations, and improving the efficiency of image desensitization.

FIG. 2D is a flow diagram illustrating a method for image desensitization according to some embodiments of the disclosure. In some embodiments, and as shown in FIG. 2D, the method includes the following steps.

Step 131: determine, in an image for desensitization, based on a desensitization rule corresponding to a service scenario with which the image for desensitization is associated, an image area first identified as meeting the desensitization rule as a first image area.

Step 132: recognize, in the image for desensitization, a second image area having content related to the content of the first image area.

Step 133: desensitize the first image area and the second image area.

In some embodiments, after an image for desensitization is determined, based on a desensitization rule corresponding to a service scenario with which the image for desensitization is associated, an image area first identified as meeting the desensitization rule is automatically recognized in the image as the first image area.

In some embodiments, relationships between images for desensitization and service scenarios, and relationships between service scenarios and desensitization rules are pre-established. As such, in step 131, desensitization rules corresponding to the service scenario with which the image for desensitization is associated are determined based on these relationships. Next, based on the desensitization rules, an image area first identified as an area that needs to be desensitized is recognized in the image as the first image area.

In some embodiments, scenario description information corresponding to different service scenarios is pre-established. The scenario description information includes information relating to service content and/or service attributes of the service scenarios. For example, the scenario description information includes information about products, scenes, people, and so on. As such, in step 131, the service scenario, with which the image for desensitization is associated, is determined based on an attribute and/or content of the image for desensitization. Next, the preset desensitization rules corresponding to the service scenario are acquired, based on which an image area first identified as needing desensitization is recognized in the image as the first image area.

In various embodiments, depending on different service scenarios, desensitization rules corresponding to the service scenarios are different. The following illustrates examples of the desensitization rules.

In one example, the desensitization rule specifies to include a personal name. As such, in step 131, an image area first identified as including a personal name in the image for desensitization is determined as the first image area.

In another example, the desensitization rule specifies to include a number. As such, in step 131, an image area first identified as including a number in the image for desensitization is determined as the first image area.

In another example, the desensitization rule specifies to include a configured keyword. As such, in step 131, an image area first identified as including the configured keyword in the image for desensitization is determined as the first image area.

In some embodiments, the first image area is automatically recognized based on the desensitization rule corresponding to the service scenario with which the image for desensitization is associated. This aspect is different from the embodiments of FIG. 1A, FIG. 2A, and FIG. 2B. Other steps are substantially similar to those in the embodiments described in connection with FIG. 1A, FIG. 2A, and FIG. 2A, and therefore, for the purpose of simplicity, the details of which are not repeated.

In various embodiments, a user does not need to manually determine any image area, as a result of which operations to manually determine an image area by the user are reduced, thereby simplifying image desensitization operations, and improving the efficiency of image desensitization.

In some embodiments, an image area to be desensitized is automatically recognized based on a desensitization rule corresponding to a service scenario with which an image for desensitization is associated. In turn, the image area is desensitized. This way, a user does not need to manually select the image area to be desensitized, thereby simplifying image desensitization operations, and improving the efficiency of desensitization.

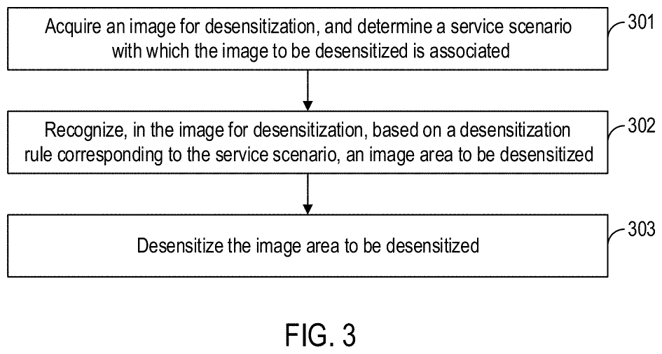

FIG. 3 is a flow diagram illustrating a method for image desensitization according to some embodiments of the disclosure. In some embodiments, and as shown in FIG. 3, the method includes the following steps.

Step 301: acquire an image for desensitization, and determine a service scenario with which the image for desensitization is associated.

Step 302: recognize, in the image for desensitization, based on a desensitization rule corresponding to the service scenario, an image area to be desensitized.

Step 303: desensitize the image area to be desensitized.

In this example, after an image for desensitization is acquired, a service scenario with which the image for desensitization is associated is determined. Next, an image area to be desensitized is recognized from the image for desensitization, based on a desensitization rule corresponding to the service scenario. Lastly, the image area to be desensitized is desensitized. In various examples, the image area to be desensitized includes an image area having sensitive information that is relatively complete in meaning. There may be one or multiple image areas to be desensitized.

In some embodiments, scenario description information corresponding to different service scenarios is pre-established. The scenario description information includes information relating to service content and/or service attributes of the service scenarios. For example, the scenario description information includes information about products, scenes, people, and so on. As such, in step 301, the service scenario with which the image for desensitization is associated is determined based on an attribute and/or content of the image for desensitization.

In various embodiments, depending on different service scenarios, desensitization rules corresponding to the service scenarios are different. The following illustrates some examples of the desensitization rules.

In one example, the desensitization rule specifies to include a personal name. As such, in step 302, an image area including a personal name in the image for desensitization is determined as the image area to be desensitized.

In another example, the desensitization rule specifies to include a number. As such, in step 302, an image area including a number in the image for desensitization is determined as the image area to be desensitized.

In still another example, the desensitization rule specifies to include a configured keyword. As such, in step 302, an image area including the configured keyword in the image for desensitization is determined as the image area to be desensitized.

In some embodiments, in step 303, a default desensitization method is used to desensitize the image area to be desensitized. In other embodiments, in step 303, a desensitization method selected by a user is determined in response to an operation performed by the user to select the desensitization method. In turn, the desensitization method selected by the user is used to desensitize the image area to be desensitized.

In this example, an image area to be desensitized is recognized in an image from desensitization, based on a desensitization rule corresponding to a service scenario with which the image for desensitization is associated. As such, a user does not need to manually determine the image area to be desensitized. This way, operations to manually determine an image area by the user are reduced, thereby simplifying image desensitization operations, and improving the efficiency of image desensitization.

In some embodiments, a complete set of image areas to be desensitized is acquired by automatic extensions based on a selected partial image area. In turn, the complete set of image areas is desensitized. Therefore, a user needs only to manually select a partial area, instead of manually selecting all the image areas (e.g., image areas in the complete set of image areas) that need to be desensitized. This way, difficulties in delineating a boundary during the selection of an image area by the user are alleviated, improving the efficiency of desensitization.

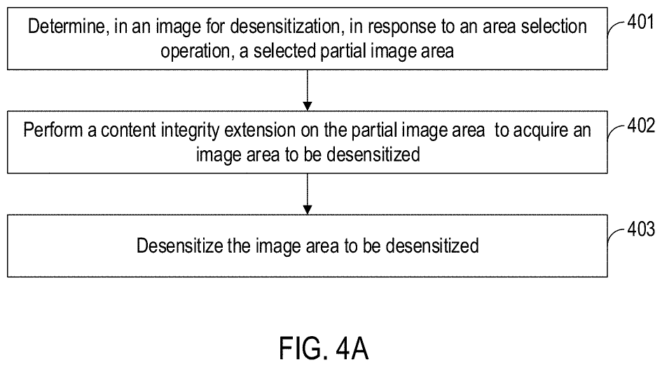

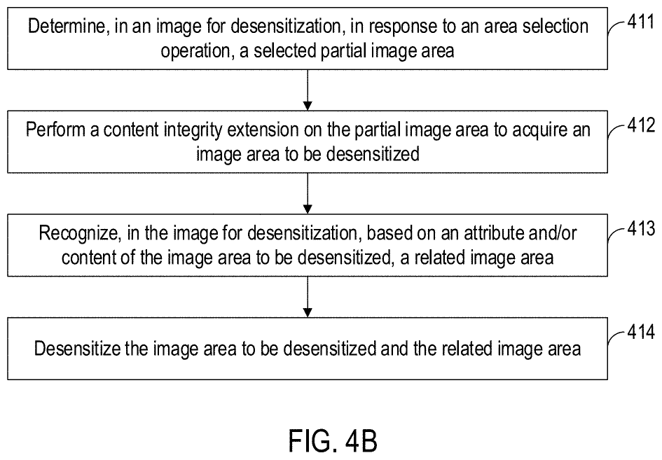

FIG. 4A is a flow diagram illustrating a method for image desensitization according to some embodiments of the disclosure. In some embodiments, and as shown in FIG. 4A, the method includes the following steps.

Step 401: determine, in an image for desensitization, in response to an area selection operation, a selected partial image area.

Step 402: perform a content integrity extension on the partial image area to acquire an image area to be desensitized.

Step 403: desensitize the image area to be desensitized.

According to various embodiments, methods for image desensitization are applicable to any electronic device that needs to perform image desensitization. Such electronic device includes any device having computing and processing capabilities. For example, an electronic device is a client device (e.g., a desktop computer, a personal computer, a tablet computer, a smartphone, etc.) In other examples, an electronic device is a server device (e.g., a conventional server, a cloud server, a cloud host, a virtual center, etc.)

In some application scenarios of an electronic device, images need to be desensitized. In some embodiments, an image that needs to be desensitized is referred to as an image for desensitization. Depending on different application scenarios, methods for determining an image for desensitization are different. For example, in some scenarios, a user selects an image to be desensitized from a local image gallery of an electronic device. In response to the operation performed by the user for selecting the image from the local image gallery, the electronic device acquires the image selected by the user as the image to be desensitized. In other scenarios, the user performs a screenshotting operation on a screen of the electronic device. In turn, the electronic device acquires a screenshot image of the current screen in response to the screenshotting operation performed by the user, and use the screenshot image as an image to be desensitized.

After the image for desensitization is determined, the user performs an area selection operation on the electronic device. In one example, the electronic device is configured to display the image for desensitization to the user, and the user performs operations such as boxing, clicking, or sliding on the image for desensitization. The electronic device is configured to determine, in response to the area selection operation, a selected partial image area on the image to be desensitized. In some embodiments, the partial image area is a portion of an image area including sensitive information that is relatively complete in meaning. That is, the partial image area selected by the area selection operation is an image area including a portion of sensitive information, the portion of the information is relatively incomplete in meaning. As shown in FIG. 2C, an image area, in which a complete phone number is located, is an image area including sensitive information that is relatively complete in meaning; and an image area enclosed by a dotted circle is a portion of the image area in which the complete phone number is located (e.g., the image area selected by an area selection operation).

Subsequently, the electronic device is configured to perform content integrity extensions on the partial image area to acquire the image area including sensitive information that is relatively complete in meaning, which is an image area to be desensitized. Next, the electronic device is configured to desensitize the image area to be desensitized.

In some embodiments, after the partial image area selected by the area selection operation is determined, content integrity extensions are performed on the partial image area based on attributes of the partial image area. In one example, a content block generally has the same color in an image. Therefore, the partial image area selected by the area selection operation is extended, based on the color of the partial image area selected by the area selection operation, to the boundary of a content block to which the partial image area belongs to acquire the image area to be desensitized. In another example, the text content of a content block is continuous in an image. Therefore, the partial image area selected by the area selection operation is extended, based on the text content of the partial image area selected by the area selection operation, to the boundary of a content block to which the partial image area belongs to acquire the image area to be desensitized.

In some embodiments, in step 403, a default desensitization method is used to desensitize the image area to be desensitized. In other embodiments, in step 403, a desensitization method selected by the user is determined in response to an operation performed by the user for selecting the desensitization method, which is used to desensitize the image area to be desensitized.

In this example, a user needs only to manually determine a partial image area in an image area for desensitization. The image area to be desensitized is acquired by automatic extensions on the partial image area; and the user does not need to manually determine the boundary of the image area to be desensitized. Therefore, the problem that a boundary is difficult to delineate during manual designation of an image area to be desensitized is solved, and operations to manually determine an image area by the user are reduced, thereby simplifying image desensitization operations, and improving the efficiency of image desensitization.

In some embodiments, as the image for desensitization includes correlating content, to further reduce the risk of information leakage, it is necessary to desensitize all of the related content. As such, after the image area to be desensitized is determined, a related image area having content related to the content of the image area to be desensitized in the image is recognized using image recognition technologies. In some embodiments, such recognition is based on content relevance. In turn, the related image area is desensitized.

In some embodiments, the order of desensitizing the image area to be desensitized and recognizing the related image area is not limited. In one example, the image area to be desensitized is desensitized first, and next, the related image area is recognized and desensitized. In another example, after the image area to be desensitized is determined, the related image area is recognized first, next the image area to be desensitized, and the related image area, are desensitized. In another example, after the image area to be desensitized is determined, the operation of desensitizing the image area to be desensitized and the operation of recognizing the related image area are performed in parallel.

FIG. 4B is a flow diagram illustrating f a method for image desensitization according to some embodiments of the disclosure. In some embodiments, and as shown in FIG. 4B, the method includes the following steps.

Step 411: determine, in an image for desensitization, in response to an area selection operation, a selected partial image area.

Step 412: perform content integrity extensions on the partial image area to acquire an image area to be desensitized.

Step 413: recognize, in the image for desensitization, based on an attribute and/or content of the image area to be desensitized, a related image area.

Step 414: desensitize the image area to be desensitized and the related image area.

In some embodiments, after an image area to be desensitized is determined, a related image area is recognized first, and then the image area to be desensitized and the related image area are desensitized.

In some embodiments, other image areas having the same image attributes as that of the image area to be desensitized are recognized from the image based on the attributes of the image area. The recognized other image areas are designated as related image areas.

In some embodiments, other image areas including the same content as the content included in the image area to be desensitized are recognized from the image based on the content of the image area. The recognized other image areas are designated as related image areas.

In some embodiments, other image areas including content belonging to the same category as that of the content included in the image area to be desensitized are recognized from the image based on the category of the content of the image area. The recognized other image areas are designated as related image areas.

In some embodiments, other image areas having both the same attributes and content as those of the image area to be desensitized are recognized from the image based on the attributes and the content of the image area. The recognized other image areas are designated as related image areas.

In some embodiments, other image areas having both the same attributes and category of content as those of the image area to be desensitized are recognized from the image based on the attributes and the category of the content of the image area. The recognized other image areas are designated as related image areas.

In step 414, in some embodiments, the image area to be desensitized and the related image area are desensitized separately. In other embodiments, the image area to be desensitized and the related image area are desensitized simultaneously. In embodiments in which the image area to be desensitized and the related image area are desensitized separately, the image area to be desensitized is desensitized when the image area to be desensitized is acquired; and the related image area is desensitized when the related image area is recognized.

In some embodiments, during the process of desensitizing the related image area, a desensitization confirmation page is displayed to the user such that the user confirms whether to desensitize the related image area. In turn, the related image area is desensitized in response to a confirmation operation performed by the user.

According to various embodiments, the steps of the methods provided in the above-described embodiments may be performed by the same device, or by different devices. In one example, step 101 to step 103 are performed by a device A. In another example, steps 101 and 102 are performed by device A; while step 103 is performed by device B; and so on.

Further, processes described herein or depicted in the drawings include a plurality of operations illustrated in a specific order. However, these operations may be performed without following the specific order or may be performed in parallel. Serial numbers of operations such as 101 and 102 are used only to distinguish different operations, not intended as any performing order. Additionally, these processes may include more or fewer operations/steps, and these operations/steps may be performed in sequence or in parallel. The descriptions such as “first” and “second” are used herein to distinguish between different messages, devices, modules, and the like, not imposing any precedence order or limiting that the “first” and “second” are of different types.

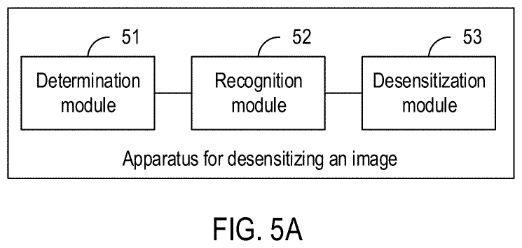

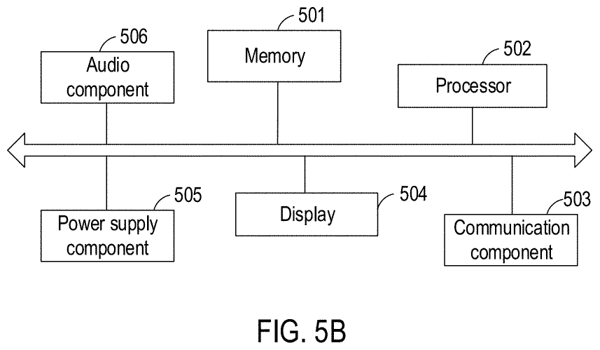

FIG. 5A is a block diagram illustrating an apparatus for image desensitization according to some embodiments of the disclosure. In some embodiments, as shown in FIG. 5A, the apparatus includes a determination module (51), a recognition module (52), and a desensitization module (53).

The determination module (51) is configured to determine, in an image for desensitization, a first image area that needs to be desensitized.

The recognition module (52) is configured to recognize, in the image for desensitization, a second image area having content related to the content of the first image area.

The desensitization module (53) is configured to desensitize the first image area and the second image area.

In some embodiments, the determination module (51) is further configured to determine, in the image for desensitization, in response to a first operation performed by a user for selecting an area for desensitization, an image area selected by the first operation as the first image area.

In some embodiments, the determination module (51) is further configured to determine, in the image for desensitization, in response to a second operation performed by the user for selecting an area for desensitization, an image area selected by the second operation; and perform content integrity extensions on the image area selected by the second operation to acquire the first image area.

In some embodiments, the determination module (51) is further configured to determine, in the image for desensitization, based on a desensitization rule corresponding to a service scenario with which the image to be desensitized is associated, an image area first identified as meeting the desensitization rule as the first image area.

In some embodiments, in response to the first operation or the second operation performed by the user for selecting an area in the image for desensitization, to determine the image area selected by the first operation or the second operation, the determination module (51) is configured to: determine, in response to a sliding operation performed by the user on the image for desensitization, an image area that has been slid across by the sliding operation; or determine, in response to a clicking operation performed by the user on the image for desensitization, an image area that has been clicked by the clicking operation; or determine, in response to a boxing operation performed by the user on the image for desensitization, an image area that has been boxed by the boxing operation.

In some embodiments, when performing content integrity extensions on the image area selected by the second operation to acquire the first image area, the determination module (51) is further configured to: extend, based on the color or text content of the image area selected by the second operation, the image area selected by the second operation to a boundary of a content block to which the image area belongs to acquire the first image area.

In some embodiments, when determining, in the image to be desensitized, based on a desensitization rule corresponding to a service scenario with which the image to be desensitized is associated, an image area first identified as meeting the desensitization rule as the first image area, the determination module (51) is further configured to: determine, in the image for desensitization, an image area first identified as including a personal name to be the first image area; or determine, in the image for desensitization, an image area first identified as including a number to be the first image area; or determine, in the image for desensitization, an image area first identified as including a configured keyword to be the first image area.

In some embodiments, the recognition module (52) is further configured to: acquire, from the image for desensitization, an image area including the same content in the first image area as the second image area; or acquire, from the image for desensitization, an image area including content belonging to the same category as that of the content included in the first image area as the second image area.

In some embodiments, the desensitization module (53) is further configured to: display a desensitization confirmation interface such that a user confirms whether to desensitize the first image area and the second image area; and desensitize the first image area and the second image area in response to a confirmation operation performed by the user.

In some embodiments, the desensitization module (53) is further configured to display an area selection interface such that a user selects, from the first image area and the second image area, a finalized image area that needs to be desensitized; and desensitize, in response to the operation performed by the user for selecting the finalized desensitization area, an image area selected by the user, the image area selected by the user including the first image area and/or the second image area.

In some embodiments, the desensitization module (53) is further configured to: use a default desensitization method to desensitize the first image area and the second image area; or use, in response to an operation performed by the user for selecting a desensitization method, a desensitization method selected by the user to desensitize the first image area and the second image area.

In some embodiments, before determining a first image area in an image for desensitization, the determination module (51) is further configured to: acquire, in response to a screenshotting operation performed by the user, a screenshot image of a current screen as the image for desensitization.

FIG. 5B is a block diagram illustrating an electronic device for image desensitization according to some embodiments of the disclosure. In some embodiments and as shown in FIG. 5B, the electronic device includes a memory (501), and a processor (502).

The memory (501) is configured to store a computer program, and other data to support operations on the electronic device. Examples of the data include instructions for applications or operations for execution on the electronic device, contact data, phonebook data, messages, pictures, videos, etc.

The memory (501) may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The processor (502) is coupled to the memory (501) and configured to execute the computer program stored in the memory (501) to: determine, in an image for desensitization, a first image area that needs to be desensitized; recognize, in the image for desensitization, a second image area having content related to the content of the first image area; and desensitize the first image area and the second image area.

In some embodiments, when determining a first image area, the processor (502) is further configured to: determine, in the image for desensitization, in response to a first operation performed by a user for selecting an area for desensitization, an image area selected by the first operation as the first image area; or determine, in the image for desensitization, in response to a second operation performed by a user for selecting an area for desensitization, an image area selected by the second operation, and perform a content integrity extension on the image area selected by the second operation to acquire the first image area; or determine, in the image for desensitization, based on a desensitization rule corresponding to a service scenario with which the image to be desensitized is associated, an image area first identified as meeting the desensitization rule as the first image area.

In some embodiments, when determining, in the image for desensitization, in response to a first operation or a second operation performed by a user for selecting an area for desensitization, an image area selected by the first operation or the second operation, the processor (502) is further configured to: determine, in response to a sliding operation performed by the user on the image to be desensitized, an image area that has been slid across by the swiping operation; or determine, in response to a clicking operation performed by the user on the image for desensitization, an image area that has been clicked by the clicking operation; or determine, in response to a boxing operation performed by the user on the image for desensitization, an image area that has been boxed by the boxing operation.

In some embodiments, when performing a content integrity extension on the image area selected by the second operation to acquire the first image area, the processor (502) is further configured to: extend, based on the color or text content of the image area selected by the second operation, the image area selected by the second operation to a boundary of a content block to which the image area belongs to acquire the first image area.

In some embodiments, when determining, in the image for desensitization, based on a desensitization rule corresponding to a service scenario with which the image for desensitization is associated, an image area first identified as meeting the desensitization rule as the first image area, the processor (502) is further configured to: determine, in the image for desensitization, an image area first identified as including a personal name as the first image area; or determine, in the image for desensitization, an image area first identified as including a number as the first image area; or determine, in the image for desensitization, an image area first identified as including a configured keyword as the first image area.

In some embodiments, when recognizing a second image area, the processor (502) is further configured to: acquire, from the image for desensitization, an image area including the same content in the first image area, and designate the image area as the second image area; or acquire, from the image for desensitization, an image area including content belonging to the same category as that of the content included in the first image area, and designate the image area as the second image area.

In some embodiments, when desensitizing the first image area and the second image area, the processor (502) is further configured to: display a desensitization confirmation interface such that a user confirms whether to desensitize the first image area and the second image area; and desensitize the first image area and the second image area in response to a confirmation operation performed by the user. In other embodiments, the processor (502) is configured to display an area selection interface such that a user selects, from the first image area and the second image area, a finalized image area that needs to be desensitized; and desensitize, in response to the operation performed by the user for selecting the finalized desensitization area, the image area selected by the user. In some embodiments, the image area selected by the user including the first image area and/or the second image area.

In some embodiments, when desensitizing the first image area and the second image area, the processor (502) is further configured to: use a default desensitization method to desensitize the first image area and the second image area; or use, in response to an operation performed by the user for selecting a desensitization method, a desensitization method selected by the user to desensitize the first image area and the second image area.

In some embodiments, before determining, in an image for desensitization, a first image area, the processor (502) is further configured to: acquire, in response to a screenshotting operation performed by the user, a screenshot image of a current screen as the image to be desensitized.

In some embodiments, and as shown in FIG. 5B, the electronic device further includes a communication component (503), a display (504), a power supply component (505), an audio component (506), and other components. FIG. 5B shows some of the optional components, without intended as indicating that the electronic device includes only the components shown in FIG. 5B, or that the electronic device necessarily includes all of the components shown in FIG. 5B. Depending on different implementations, the electronic device may flexibly include different components.

Embodiments of the disclosure further provide a computer-readable storage medium for storing a computer program thereon that, when executed by a processor, causes the processor to perform the embodiments shown in FIGS. 1A-4B.

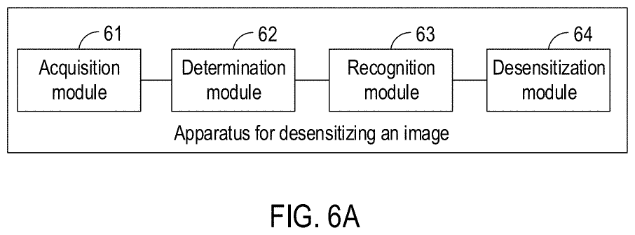

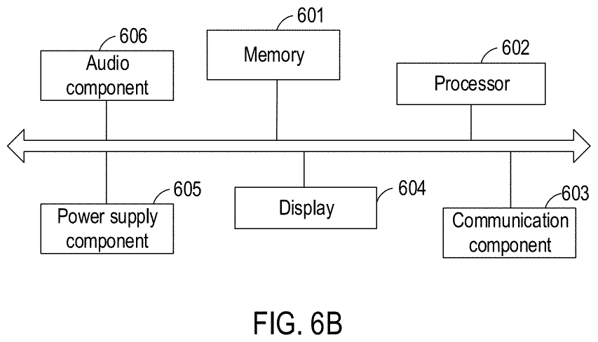

FIG. 6A is a block diagram illustrating an apparatus for image desensitization according to some embodiments of the disclosure. In some embodiments and as shown in FIG. 6A, the apparatus includes an acquisition module (61), a determination module (62), a recognition module (63), and a desensitization module (64).

The acquisition module (61) is configured to acquire an image for desensitization.

The determination module (62) is configured to determine a service scenario with which the image for desensitization is associated.

The recognition module (63) is configured to recognize, in the image for desensitization, based on a desensitization rule corresponding to the service scenario, an image area to be desensitized.

The desensitization module (64) is configured to desensitize the image area to be desensitized.

In some embodiments, the acquisition module (61) is further configured to: acquire, in response to a screenshotting operation performed by a user, a screenshot image of a current screen as the image to be desensitized.

In some embodiments, the determination module (62) is further configured to determine, based on an attribute and/or content of the image to be desensitized, the service scenario with which the image for desensitization is associated.

In some embodiments, the recognition module (63) is further configured to: determine, in the image for desensitization, an image area first identified as including a personal name as the image area to be desensitized; o determine, in the image for desensitization, an image area first identified as including a number as the image area to be desensitized; or determine, in the image for desensitization, an image area first identified as including a configured keyword to be the image area as desensitized.

In some embodiments, the desensitization module (64) is further configured to: use a default desensitization method to desensitize the image area to be desensitized; or use, in response to an operation performed by the user for selecting a desensitization method, a desensitization method selected by the user to desensitize the image area to be desensitized.

In some embodiments, the desensitization module (64) is further configured to: display a desensitization confirmation interface such that the user confirms whether to desensitize the image area to be desensitized; and desensitize, in response to a confirmation operation performed by the user, the image area to be desensitized.

FIG. 6B is a block diagram illustrating an electronic device for image desensitization according to some embodiments of the disclosure. In some embodiments, and as shown in FIG. 6B, the apparatus includes a memory (601), and a processor (602).

The memory (601) is configured to store a computer program, and other data to support operations on the electronic device. Examples of the data include instructions for applications or operations for executing on the electronic device, contact data, phonebook data, messages, pictures, videos, etc.

The memory (601) may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The processor (602) is coupled to the memory (601) and configured to execute the computer program stored in the memory (601) to: acquire an image for desensitization, and determine a service scenario with which the image for desensitization is associated; and recognize, in the image for desensitization, abased on a desensitization rule corresponding to the service scenario, an image area to be desensitized; and desensitize the image area to be desensitized.

In some embodiments, when acquiring an image for desensitization, the processor (602) is further configured to: acquire, in response to a screenshotting operation performed by a user, a screenshot image of a current screen as the image to be desensitized.

In some embodiments, when determining a service scenario with which the image to be desensitized is associated, the processor (602) is further configured to determine, based on an attribute and/or content of the image for desensitization, the service scenario with which the image to be desensitized is associated.

In some embodiments, when recognizing an image area to be desensitized, the processor (602) is further configured to: determine, in the image for desensitization, an image area first identified as including a personal name as the image area to be desensitized; or determine, in the image for desensitization, an image area first identified as including a number as the image area to be desensitized; or determine, in the image for desensitization, an image area first identified as including a configured keyword as the image area to be desensitized.

In some embodiments, when desensitizing the image area to be desensitized, the processor (602) is further configured to: use a default desensitization method to desensitize the image area to be desensitized; or use, in response to an operation performed by the user for selecting a desensitization method, a desensitization method selected by the user to desensitize the image area to be desensitized.

In some embodiments, when desensitizing the image area to be desensitized, the processor (602) is further configured to: display a desensitization confirmation interface such that the user confirms whether to desensitize the image area to be desensitized; and desensitize, in response to a confirmation operation performed by the user, the image area to be desensitized.

In some embodiments, and as shown in FIG. 6B, the electronic device further includes a communication component (603), a display (604), a power supply component (605), an audio component (606), and other components. FIG. 6B shows some optional components, without intended as indicating that the electronic device includes only the components shown in FIG. 6B, or that the electronic device necessarily includes all of the components shown in FIG. 6B. Depending on different implementations, the electronic device may flexibly include different components.

In some embodiments, embodiments of the disclosure further provide a computer-readable storage medium for storing a computer program thereon that, when executed by a processor, causes the processor to perform the embodiments shown in FIG. 3.

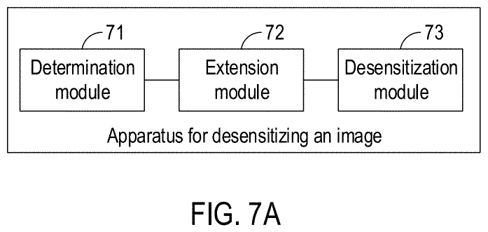

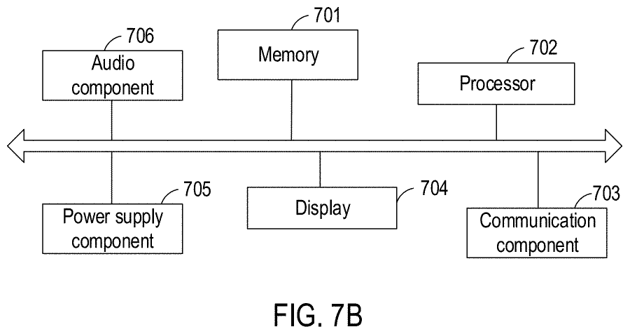

FIG. 7A is a block diagram illustrating an apparatus for image desensitization according to some embodiments of the disclosure. In some embodiments, and as shown in FIG. 7A, the apparatus includes a determination module (71), an extension module (72), and a desensitization module (73).

The determination module (71) is configured to determine, in an image for desensitization, in response to an area selection operation, a selected partial image area.

The extension module (72) is configured to perform a content integrity extension on the partial image area to acquire an image area to be desensitized.

The desensitization module (73) is configured to desensitize the image area to be desensitized.

In some embodiments, the desensitization module (73) is further configured to: recognize, in the image for desensitization, based on an attribute and/or content of the image area to be desensitized, a related image area; and desensitize the related image area.

In some embodiments, when recognizing a related image area, the desensitization module (73) is further configured to: acquire, from the image for desensitization, an image area including the same content in the image area to be desensitized, and designate the image area as the related image area. Additionally, or alternatively, in other embodiments, the desensitization module (73) is further configured to, acquire, from the image for desensitization, an image area including content belonging to the same category as that of the content included in the image area to be desensitized, and designate the image area as the related image area.

In some embodiments, when desensitizing the related image area, the desensitization module (73) is further configured to display a desensitization confirmation page such that a user confirms whether to desensitize the related image area; and desensitize the related image area in response to a confirmation operation performed by the user.

FIG. 7B is a block diagram illustrating an electronic device for image desensitization according to some embodiments of the disclosure. In some embodiments, and as shown in FIG. 7B, the electronic device includes a memory (701), and a processor (702).

The memory (701) is configured to store a computer program, and other data to support operations on the electronic device. Examples of the data include instructions for applications or operations for executing on the electronic device, contact data, phonebook data, messages, pictures, videos, etc.

The memory (701) may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The processor (702) is coupled to the memory (701) and configured to execute the computer program stored in the memory (701) to determine, in an image for desensitization, in response to an area selection operation, a selected partial image area; perform a content integrity extension on the partial image area to acquire an image area to be desensitized; and desensitize the image area to be desensitized.

In some embodiments, the processor (702) is further configured to: recognize, in the image for desensitization, based on an attribute and/or content of the image area to be desensitized, a related image area; and desensitize the related image area.

In some embodiments, when recognizing a related image area, the processor (702) is further configured to: acquire, from the image for desensitization, an image area including the same content of the image area to be desensitized, and designate the image area as the related image area; and/or acquire, from the image for desensitized, an image area including content belonging to the same category as that of the content included in the image area to be desensitized, and designate the image area as the related image area.

In some embodiments, when desensitizing the related image area, the processor (702) is further configured to display a desensitization confirmation page such that a user confirms whether to desensitize the related image area; and desensitize the related image area in response to a confirmation operation performed by the user.

In some embodiments, and as shown in FIG. 7B, the electronic device further includes a communication component (703), a display (704), a power supply component (705), an audio component (706), and other components. FIG. 7B shows some optional components, without intended as indicating that the electronic device includes only the components shown in FIG. 7B, or that the electronic device necessarily includes all of the components shown in FIG. 7B. Depending on different implementations, the electronic device may flexibly include different components.

In some embodiments, embodiments of the disclosure further provide a computer-readable storage medium for storing a computer program thereon that, when executed by a processor, causes the processor to perform the embodiments shown in FIGS. 4A-4B.

In various embodiments, the communication component in FIG. 5B, FIG. 6B, and FIG. 7B is configured to facilitate wired or wireless communication between a device in which the communication component is located and other devices. The device to which the communication component is located can access a wireless network based on a communication standard, such as Wi-Fi, 2G, or 3G, or a combination thereof. In one embodiment, the communication component receives an advertisement signal or advertisement-related information from an external advertisement management system via an advertisement channel. In one embodiment, the communication component further includes a Near Field Communication (NFC) module to facilitate short-range communications. For example, the NFC module may be implemented based on a radio frequency identification (RFID) technology, an Infrared Data Association (IrDA) technology, an ultra-wideband (UWB) technology, a Bluetooth (BT) technology, and other technologies.

In various embodiments, the display in FIG. 5B, FIG. 6B, and FIG. 7B includes a screen that may include a Liquid Crystal Display (LCD) and a Touch Panel (TP). If the screen includes the touch panel, then the screen may be implemented as a touch screen to receive input signals from a user. The touch panel includes one or a plurality of touch sensors to sense touches, swipes, slides, and gestures on the touch panel. The touch sensors may not only sense the boundary of a touch or swipe or slide action but also detect duration and pressure related to the touch or swipe or slide operation.

In various embodiments, the power supply component in FIG. 5B, FIG. 6B, and FIG. 7B supplies power to various components of the device in which the power supply component is located. The power supply component may include a power management system, one or a plurality of power sources, and other components associated with the generation, management, and distribution of power for the device in which the power supply component is located.

In various embodiments, the audio component in FIG. 5B, FIG. 6B, and FIG. 7B is configured to output and/or input audio signals. For example, the audio component includes a microphone (MIC) configured to receive an external audio signal when a device in which the audio component is located in an operation mode, such as a call mode, a recording mode, and a voice recognition mode. The received audio signal may further be stored in the memory or sent via the communication component. In some embodiments, the audio component further includes a speaker to output audio signals.

Those skilled in the art should understand that the embodiments of the disclosure may be provided as a method, a system, or a computer program product. Therefore, the present invention may use the form of a full hardware embodiment, a full software embodiment, or an embodiment combining software and hardware. Moreover, the present invention may use the form of a computer program product implemented on one or a plurality of computer-usable storage media (including, but not limited to, a magnetic disk memory, a CD-ROM, an optical memory, etc.) containing computer-usable program code therein.

The present invention is described with reference to flowcharts and/or block diagrams of a method, a device (system), and a computer program product according to the embodiments of the present invention. It should be understood that each procedure and/or block in the flowcharts and/or block diagrams, and a combination of procedures and/or blocks in the flowcharts and/or block diagrams may be implemented with computer program instructions. These computer program instructions may be provided to a processor of a general-purpose computer, a special-purpose computer, an embedded processor, or any other programmable data processing device to produce a machine, so that instructions executed by the processor of the computer or other programmable data processing device generate means for implementing a specified function in one or a plurality of procedures in the flowcharts and/or one or a plurality of blocks in the block diagrams.

These computer program instructions may also be stored in a computer-readable memory that can direct a computer or any other programmable data processing device to operate in a particular manner so that the instructions stored in the computer-readable memory produce an article of manufacture including instruction means, the instruction means implementing a specified function in one or a plurality of procedures in the flowcharts and/or one or a plurality of blocks in the block diagrams.

These computer program instructions may also be loaded onto a computer or any other programmable data processing device so that a series of operational steps are performed on the computer or other programmable device to produce computer-implemented processing, and thus the instructions executed on the computer or other programmable device provide the steps for implementing a specified function in one or a plurality of procedures in the flowcharts and/or one or a plurality of blocks in the block diagrams.

In a typical configuration, the computing device includes one or a plurality of processors (CPUs), input/output interfaces, network interfaces, and memories.

The memory may include a computer-readable medium in the form of a non-permanent memory, a Random Access Memory (RAM) and/or non-volatile memory or the like, such as a Read-Only Memory (ROM) or a flash memory (flash RAM). Memory is an example of a computer-readable medium.

The computer-readable medium includes permanent and non-permanent, movable and non-movable media that can achieve information storage by means of any methods or techniques. The information may be a computer-readable instruction, a data structure, a module of a program, or other data. Examples of a storage medium of a computer include, but are not limited to, a Phase Change Memory (PRAM), a Static Random Access Memory (SRAM), a Dynamic Random Access Memory (DRAM), other types of Random Access Memories (RAMs), a Read-Only Memory (ROM), an Electrically Erasable Programmable Read-Only Memory (EEPROM), a flash memory or other memory technologies, a Compact Disk Read-Only Memory (CD-ROM), a Digital Versatile Disc (DVD) or other optical storages, a cassette tape, a magnetic tape/magnetic disk storage or other magnetic storage devices, or any other non-transmission medium, and can be used to store information accessible by a computing device. According to the definitions herein, the computer-readable medium does not include transitory computer-readable media (transitory media), such as a modulated data signal and a carrier wave.

It should further be noted that the term “include,” “comprise,” or any other variation thereof is intended to encompass a non-exclusive inclusion, so that a process, method, commodity, or device that includes a series of elements includes not only those elements but also other elements not explicitly listed, or elements that are inherent to such a process, method, commodity, or device. The element defined by the statement “including one . . . ,” without further limitation, does not preclude the presence of additional identical elements in the process, method, commodity, or device that includes the element.

The above descriptions are merely the embodiments of the disclosure and are not intended to limit the disclosure. For those skilled in the art, the disclosure may have various alterations and changes. Any modifications, equivalent substitutions, improvements and the like made within the spirit and principle of the disclosure shall fall within the scope of the claims of the disclosure.

1-22. (canceled)

23. A method comprising:
determining, by a processor, a first image area in an image, the first area comprising a portion of the image that needs to be desensitized;
identifying, by the processor, a second image area in the image, the second image area having content related to content of the first image area; and
desensitizing, by the processor, the first image area and the second image area.

24. The method of claim 23, the determining the first image area comprising receiving a selection of the first image area by a user.

25. The method of claim 24, the selection comprising an operation selected from the group consisting of a sliding, clicking, or boxing operation.

26. The method of claim 24, further comprising performing a content integrity extension on the first image area.

27. The method of claim 26, the performing the content integrity extension comprising extending, based on a color or textual content of the first image area, the first image area to a boundary of a content block to which the first image area belongs.

28. The method of claim 23, the determining the first image area comprising determining the first image area based on a desensitization rule corresponding to a service scenario associated with the image.

29. The method of claim 23, the identifying the second image area comprising identifying the second image area based on a condition selected from the group consisting of:
the second image area including content same as the content of the first image area; and
the second image area comprising content belonging to a same category of the content of the first image area.

30. A non-transitory computer-readable storage medium for tangibly storing computer program instructions capable of being executed by a computer processor, the computer program instructions defining the steps of:
determining, by the computer processor, a first image area in an image, the first area comprising a portion of the image that needs to be desensitized;
identifying, by the computer processor, a second image area in the image, the second image area having content related to content of the first image area; and
desensitizing, by the computer processor, the first image area and the second image area.

31. The computer-readable storage medium of claim 30, the step of determining the first image area comprising receiving a selection of the first image area by a user.

32. The computer-readable storage medium of claim 31, the selection comprising an operation selected from the group consisting of a sliding, clicking, or boxing operation.

33. The computer-readable storage medium of claim 31, the computer program instructions further defining the step of performing a content integrity extension on the first image area.

34. The computer-readable storage medium of claim 33, the step of performing the content integrity extension comprising extending, based on a color or textual content of the first image area, the first image area to a boundary of a content block to which the first image area belongs.

35. The computer-readable storage medium of claim 30, the step of determining the first image area comprising determining the first image area based on a desensitization rule corresponding to a service scenario associated with the image.

36. The computer-readable storage medium of claim 30, the step of identifying the second image area comprising identifying the second image area based on a condition selected from the group consisting of:
the second image area including content same as the content of the first image area; and
the second image area comprising content belonging to a same category of the content of the first image area.

37. A device comprising:
a processor; and
a storage medium for tangibly storing thereon program logic for execution by the processor, the stored program logic comprising:
logic, executed by the processor, for determining a first image area in an image, the first area comprising a portion of the image that needs to be desensitized;
logic, executed by the processor, for identifying a second image area in the image, the second image area having content related to content of the first image area; and
logic, executed by the processor, for desensitizing the first image area and the second image area.

38. The device of claim 37, the logic for determining the first image area comprising logic, executed by the processor, for receiving a selection of the first image area by a user.

39. The device of claim 38, the stored program logic further comprising logic, executed by the processor, for performing a content integrity extension on the first image area.

40. The device of claim 39, the logic for performing the content integrity extension comprising logic, executed by the processor, for extending, based on a color or textual content of the first image area, the first image area to a boundary of a content block to which the first image area belongs.

41. The device of claim 37, the logic for determining the first image area comprising logic, executed by the processor, for determining the first image area based on a desensitization rule corresponding to a service scenario associated with the image.

42. The device of claim 37, the logic for identifying the second image area comprising logic, executed by the processor, for identifying the second image area based on a condition selected from the group consisting of:
the second image area including content same as the content of the first image area; and
the second image area comprising content belonging to a same category of the content of the first image area.
